(19) United States
(12) Patent Application Publication
(10) Pub. No.: US 2014/0292706 A1
(43) Pub. Date: Oct. 2, 2014

(54) NON-VISUAL TOUCH INPUT TARGETING

(71) Applicant: LENOVO (SINGAPORE) PTE. LTD., Singapore (SG)

(72) Inventors: John Miles Hunt, Raleigh, NC (US); Matthew Lloyd Hagenbuch, Durham, NC (US)

(73) Assignee: Lenovo (Singapore) Pte. Ltd., Singapore (SG)

(21) Appl. No.: 13/854,535

(22) Filed: Apr. 1, 2013

(51) Int. Cl. G06F 3/01

(52) U.S. Cl. CPC G06F 3/016
USPC 345/174

(57) ABSTRACT

An aspect provides a method, including: determining a non-operational input at a touch sensitive surface associated with an underlying control; providing initial non-visual feedback after determining the non-operational input; determining a further input at the touch sensitive surface; and providing one or more of: additional non-visual feedback; and an execution of the underlying control. Other aspects are described and claimed.

### BACKGROUND

Information handling devices (“devices”), for example cell phones, smart phones, tablet devices, laptop and desktop computers, remote controls, alarm clocks, navigation systems, e-readers, etc., employ one or more of a multitude of available input devices. Among these input devices are touch sensitive input devices, for example touch screens and touch pads having a touch sensitive surface, as well as mechanical input devices, for example track points and mechanical buttons.

Haptic feedback is commonly used in consumer electronics to provide a global response for actions such as confirming activation of controls (e.g., press and hold of an on-screen button or location) as well as providing notifications (e.g., text message received). Haptic feedback is provided using one or more actuators. Various types of actuators are used. An example actuator is a mechanical actuator that physically provides vibration via oscillation in response to electrical stimulus. Different amplitudes, frequencies and timing may be applied to an actuator to produce various forms of vibration and thus haptic feedback. For example, one vibration type may be provided to indicate a text message has been received whereas another type of vibration type may be provided to indicate a text selection action has been successfully initiated on a touch screen device. Other forms of feedback, e.g., auditory feedback, are also used in various contexts.

### BRIEF SUMMARY

In summary, one aspect provides a method, comprising: determining a non-operational input at a touch sensitive surface associated with an underlying control; providing initial non-visual feedback after determining the non-operational input; determining a further input at the touch sensitive surface; and providing one or more of: additional non-visual feedback; and an execution of the underlying control.

Another aspect provides an information handling device, comprising: a touch sensitive surface; one or more processors; a memory device assessable to the one or more processors and storing code executable by the one or more processors to perform acts comprising: determining a non-operational input at the touch sensitive surface associated with an underlying control; providing initial non-visual feedback after determining the non-operational input; determining a further input at the touch sensitive surface; and providing one or more of: additional non-visual feedback; and an execution of the underlying control.

A further aspect provides a program product, comprising: a storage device having computer readable program code stored therewith, the computer readable program code comprising: computer readable program code configured to determine a non-operational input at a touch sensitive surface associated with an underlying control; computer readable program code configured to provide initial non-visual feedback after determining the non-operational input; computer readable program code configured to determine a further input at the touch sensitive surface; and computer readable program code configured to provide one or more of: additional non-visual feedback; and an execution of the underlying control.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example information handling device having a touch sensitive surface.

FIG. 2 illustrates an example method of providing targeting or homing non-visual feedback.

FIG. 3 illustrates an example of information handling device circuitry.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Haptic (or vibratory or tactile) feedback is commonly used in consumer electronics to provide a global response for simple actions such as confirming activation of controls. Also, some simple pulsed haptic feedback has provided a sense of texture. In other examples, simple, non-directional movement, e.g., a finger sensed over a touch pad, have been provided as tactile cues to a user. Nonetheless, these uses of haptic feedback have been generally limited to using haptic feedback of unaltered frequency, amplitude, duration and/or position in the input devices. These relatively simple haptic sensations consisting of a fixed frequency, duration and amplitude are used to create feedback for various situations. Most often, a single, haptic sensation of the same fixed frequency, duration and amplitude is used as global feedback for all situations within a device.

Occasionally, some devices have implemented more than one haptic sensation as feedback for different situations but each haptic feedback sensation consists of some fixed level of frequency, duration and amplitude. In any such cases, the haptic feedback comes on to convey that a user action is being acknowledged or that a function has been actuated and turns off shortly thereafter. Thus, these haptic responses convey nothing about the qualitative nature or state of the function being used; such where touch input is needed in relation to an underlying application.

Auditory or audio feedback has also been used in a wide variety of ways. Examples include ringing or tones used to indicate certain actions are occurring (e.g., incoming phone calls, text messages, etc.) or as a warning or other indication to a user. However, auditory and haptic feedback has not been used in certain use contexts where such non-visual feedback would be appropriate and useful.

For example, in many situations (e.g., driving an automobile, during exercise, or similar activities) a user needs or wants to operate a touch screen control (e.g., play, pause, stop or skip control on a music or media player application) without looking at the information handling device (“device”). This may be extremely difficult, as the user may be unfamiliar with the underlying layout of the application controls in the touch screen (i.e., the locations of the buttons of the underlying controls). Frequently this difficulty is encountered where the touch screen application does not provide a full compliment of application controls, e.g., in circumstances where a subset of controls is provided due to a lock screen or timeout being implemented. A common example includes a music player's controls, where after a timeout the touch screen will thereafter provide only a subset of controls (unless or until the user re-opens the underlying application on the device).

While this subset of controls is convenient, the user must still avert his or her gaze from the activity at hand (e.g., driving, exercising, etc.) in order to provide input, e.g., tap, to the appropriate selection. This provides in many cases to be inconvenient at best, and may even be hazardous in certain situations. Therefore, users are left to simply look at the touch screen to make selections irrespective of other activities competing for their attention. Some assistive technologies for the visually impaired attempt to read aloud the user interface after the user makes a selection (confirmatory audible feedback). However, this solution does not assist the user in making the selection, but only indicates what selection has been made.

Accordingly, an embodiment provides a solution in which non-visual feedback or targeting feedback (e.g., tactile/haptic feedback and/or auditory feedback) is provided to assist the user via non-visual cues. The non-visual feedback provides a guiding or directional function which guides the user to the proper control.

The illustrated example embodiments will be best understood by reference to the figures. The following description is intended only by way of example, and simply illustrates certain example embodiments.

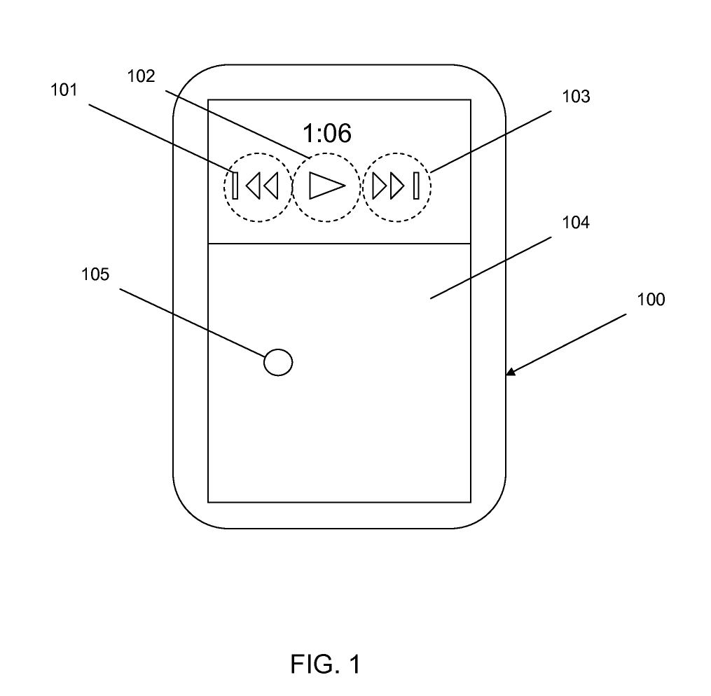

Referring to FIG. 1, an embodiment provides a solution in which non-visual feedback or targeting (e.g., tactile/haptic feedback and/or auditory feedback) is provided to assist the user via non-visual cues. When a device 100 is running for example in a mode in which an application displays a subset of controls (with respect to a full complement of controls available in the opened application), the device 100 accepts touch input at a touch screen to operate a subset of corresponding functions of the application.

In the example illustrated in FIG. 1, the device 100 has an audio player application running, which plays audio to an output device (e.g., speaker or headphones). After a predetermined time, e.g., one minute, the device 100 may enter a mode whereby the touch screen does not display the full application, but instead displays a reduced set of controls, e.g., controls for skipping forward in a queue, skipping backwards in a queue, or playing/pausing a currently queued audio file. The device 100 may likewise enter a mode whereby only a subset of zones in the touch screen are operative to control the audio player application, e.g., zones 101, 102 and 103. Thus, the user may attempt to provide touch input to a zone, e.g., 104, but this will not be perceived as operational touch input by the device 100.

In such a use context, the user needs to provide input to zones 101, 102 or 103 in order to execute an operation of an underlying control of the audio player. As described herein, in some contexts, e.g., driving, exercising, the user may not be able to or want to look at the screen to appropriately target and provide input to one of the zones, i.e., 101, 102 or 103.

Accordingly, an embodiment provides non-visual feedback to help the user home in on or target the appropriate control. The non-visual feedback provides a guiding or directional function which guides the user to the proper control. The user's finger, e.g., as placed on or near a touch screen at 104, is sensed (e.g., via change in capacitance on a touch screen or as the finger approaches the touch screen, e.g., using optics or a surface implementing hovering capability). Once the user has provided an initial input, e.g., at position 105 of zone 104, the touch sensitive surface, e.g., touch screen of device 100, provides the user with tactile feedback providing non-visual cue(s).

For example, an embodiment may provide homing zones for providing non-visual feedback to the user. In the example of FIG. 1, three audio controls (i.e., skip forward, skip backwards, play/pause) are illustrated. The user, e.g., on providing touch input to zone 104 at position 105, would hear and/or feel (depending on the nature of the non-visual feedback provided) multiple tones or levels of non-visual feedback. These tones may vary depending on the nature of the input provided, e.g., as determined by the device sensing touch input at a particular location 105 of zone 104. It should be noted that zone 104 may be divided into sub-zones or homing zones.

In the example of auditory non-visual feedback, the device 100 may provide (e.g., via speakers or headphones), and make use of stereo qualities (e.g., left of right channels or ear-buds) to cue the user that the input is either too far to the left, too far to the right, too low or too high (i.e., provide directional stereo feedback), depending on where (e.g., in which homing zone) the user has provided initial input.

In the example case of FIG. 1, the device 100 may cue the user with auditory feedback using a first low town (e.g., low frequency) to indicate that the input is too low, i.e., is located in zone 104 below the operational zones 101, 102, 103. If the user moves the input upward in zone 104, e.g., via sliding the finger along the touch screen, the frequency may gradually increase as the user homes in on operational zones 101, 102, 103.

In the event that the user reaches one of the operational zones, the device 100 may again modulate the frequency/pitch and/or another parameter, e.g., amplitude or loudness, to indicate that a particular operational zone, e.g., 101, 102 or 103 has been found by the user. The operational zones may have particular audio (or haptic) qualities assigned to them such that the user may learn which sound (or tactile feedback) accompanies touching which zone. This provides the user with guiding or directional homing feedback that is non-visual and thus does not require the user to look at the device 100.

Similarly, the device 100 may use haptic non-visual feedback to provide tactile cues to the user. In the example of FIG. 1, again if touch input is initially determined at 105, the device may start out with a particular frequency and/or amplitude of haptic feedback (e.g., oscillation of one or more actuators). The device may modulate this haptic feedback, e.g., in a similar fashion to the audio feedback described herein, in order to provide the user with a non-visual, tactile sense of where feedback is sensed and where the user needs to provide touch input in order to operate one of the subset of controls. Thus, haptic feedback may be varied according to frequency, amplitude, duration and/or position (i.e., directional haptic feedback).

The haptic and auditory feedback may be used alone or in combination with one another to provide non-visual targeting or homing feedback to the user. Following the homing or targeting feedback, the user may provide operational touch input, e.g., a double tap, to operate an underlying control from the subset of controls of the underlying application. Thus, once the user has received feedback regarding their searching or homing inputs, the user may confirm an operational input in some fashion, e.g., double tap input, press and hold for a predetermined time, or the like.

The device 100 operates differently than many assistive technologies currently available because the device 100 does not simply read out the position of the current input or the last touched or operated item/control. Thus, the device 100 actually provides targeting or homing non-visual feedback to the user prior to the user making a selection (e.g., via conformational/operational input). This supplements the user's mental image of the device landscape and provides the user with an intuitive way to navigate the touch screen controls with real-time feedback, rather than using post operational feedback or correctional feedback. Therefore, the device 100 operates to provide proactive feedback to direct or guide the user prior to sensing and execution of operational input.

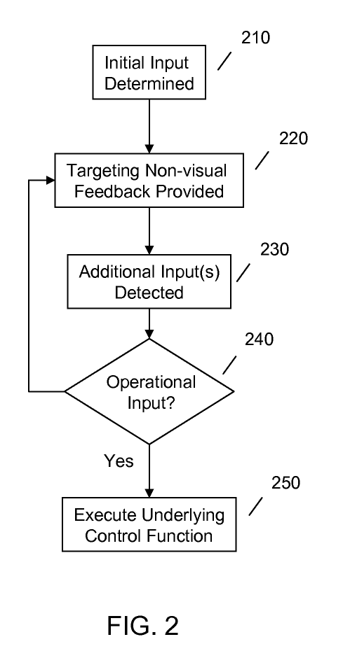

FIG. 2 illustrates an example method of providing targeting or homing non-visual feedback. The device at first senses an initial input, e.g., at a touch screen or other touch sensitive surface at 210. The input is sensed at a non-operational zone, e.g., zone 104 of FIG. 1. An embodiment provides non-visual targeting feedback to the user, e.g., via audio outputs and/or haptic feedback at 220. The device senses additional inputs at 220 and determines if these are operational inputs or targeting inputs at 240. For example, at varying distances from the subset of operational zones 101, 102 and 103 of the touch screen, as illustrated in FIG. 1, the device will detect that the user needs further targeting feedback and provide such feedback until the user enters an operational zone, e.g., 101, 102, or 103. Once the user has entered an operational zone, e.g., 101, as sensed by the change in targeting feedback of device (e.g., playing an audible sound and/or providing haptic feedback at a frequency, amplitude and/or duration indicative of an operational zone), the user may provide operational input, e.g., a double tap to the operational zone. If an operation input is determined at 240, the device will execute the underlying control of the operational zone, e.g., play, pause, skip forward, skip backwards, within the application, e.g., audio or media player application.

Therefore, an embodiment provides targeting or homing feedback of a non-visual nature. This feedback assists the user in finding (i.e., homing in on) an appropriate operational control of an underlying application such that the user need not ever look at the device. Moreover, the initial and continuing inputs may be distinguished by the device from operational controls, ensuring that inadvertent inputs given while the user is targeting or homing in on a control are not interpreted as operational inputs.

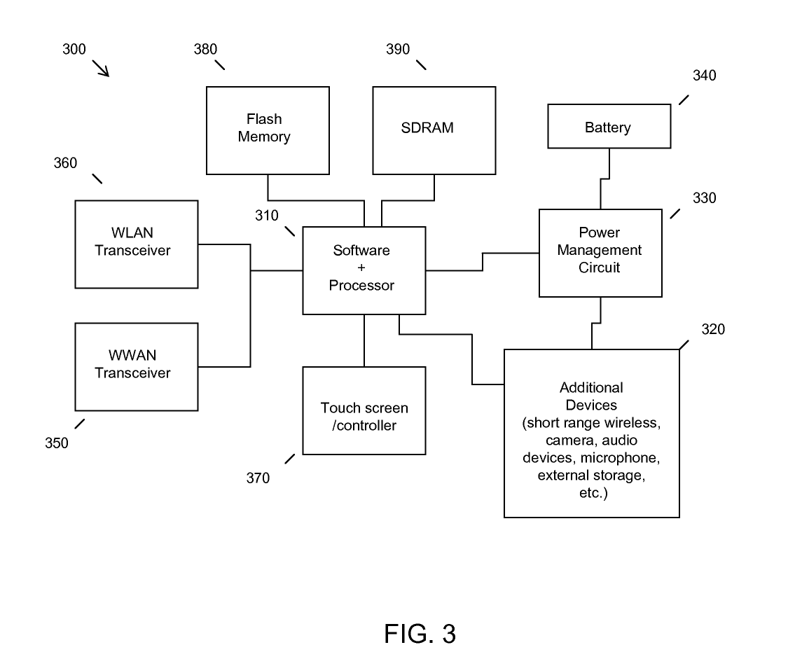

The embodiments may be used in a wide variety of devices that include a touch sensitive surface such as a touch screen. Referring to FIG. 3, while various other circuits, circuitry or components may be utilized, with regard to smart phone and/or tablet circuitry 300, an example illustrated in FIG. 3 includes an ARM based system (system on a chip) design, with software and processor(s) combined in a single chip 310. Internal busses and the like depend on different vendors, but essentially all the peripheral devices (320) may attach to a single chip 310. The circuitry 300 combines the processor, memory control, and I/O controller hub all into a single chip 310. Also, ARM based systems 300 do not typically use SATA or PCI or LPC. Common interfaces for example include SDIO and I2C.

There are power management chip(s) 330, e.g., a battery management unit, BMU, which manage power as supplied for example via a rechargeable battery 340, which may be recharged by a connection to a power source (not shown). The circuitry 300 may thus be included in a device such as the information handling device 100 of FIG. 1. In at least one design, a single chip, such as 310, is used to supply BIOS like functionality and DRAM memory.

ARM based systems 300 typically include one or more of a WWAN transceiver 350 and a WLAN transceiver 360 for connecting to various networks, such as telecommunications networks and wireless base stations. Commonly, an ARM based system 300 will include a touch screen 370 for data input and display. ARM based systems 300 also typically include various memory devices, for example flash memory 380 and SDRAM 390.

Information handling devices, as for example outlined in FIG. 1 and FIG. 3, may include touch screens that accept input for operating underlying applications, as described herein. It should be noted, however, that the example device 100 of FIG. 1 and circuitry of FIG. 3 are examples only, and other devices and circuitry may be used. Moreover, although touch screens and an audio player application have been used herein as examples, embodiments are not limited to these devices, applications, or use contexts.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
determining a non-operational input at a touch sensitive surface associated with an underlying control;
providing initial non-visual feedback after determining the non-operational input;
determining a further input at the touch sensitive surface; and
providing one or more of:
additional non-visual feedback; and
an execution of the underlying control.

2. The method of claim 1, wherein additional non-visual feedback comprises one or more of auditory feedback and haptic feedback.

3. The method of claim 2, wherein the additional non-visual feedback includes a directional cue.

4. The method of claim 2, wherein the directional cue includes one or more of variation of frequency, amplitude, duration or position of the non-visual feedback with respect to the initial non-visual feedback.

5. The method of claim 1, wherein the determining a further input comprises detecting operational input.

6. The method of claim 5, wherein the execution of the underlying control occurs after detecting operational input.

7. The method of claim 1, wherein the touch sensitive surface is a touch screen.

8. The method of claim 1, wherein the underlying control comprises one of a subset of underlying operational controls for a media player application.

9. The method of claim 2, wherein the auditory feedback comprises directional stereo feedback.

10. The method of claim 2, wherein the haptic feedback comprises directional haptic feedback.

11. An information handling device, comprising:
a touch sensitive surface;
one or more processors;
a memory device assessable to the one or more processors and storing code executable by the one or more processors to perform acts comprising:
determining a non-operational input at the touch sensitive surface associated with an underlying control;
providing initial non-visual feedback after determining the non-operational input;
determining a further input at the touch sensitive surface; and
providing one or more of:
additional non-visual feedback; and
an execution of the underlying control.

12. The information handling device of claim 11, wherein additional non-visual feedback comprises one or more of auditory feedback and haptic feedback.

13. The information handling device of claim 12, wherein the additional non-visual feedback includes a directional cue.

14. The information handling device of claim 12, wherein the directional cue includes one or more of variation of frequency, amplitude, duration or position of the non-visual feedback with respect to the initial non-visual feedback.

15. The information handling device of claim 11, wherein determining a further input comprises detecting operational input.

16. The information handling device of claim 15, wherein the execution of the underlying control occurs after detecting operational input.

17. The information handling device of claim 11, wherein the touch sensitive surface is a touch screen.

18. The information handling device of claim 11, wherein the underlying control comprises one of a subset of underlying operational controls for a media player application.

19. The information handling device of claim 12, wherein the auditory feedback comprises directional stereo feedback, and further wherein the haptic feedback comprises directional haptic feedback.

20. A program product, comprising:
a storage device having computer readable program code stored therewith, the computer readable program code comprising:
computer readable program code configured to determine a non-operational input at a touch sensitive surface associated with an underlying control;
computer readable program code configured to provide initial non-visual feedback after determining the non-operational input;
computer readable program code configured to determine a further input at the touch sensitive surface; and
computer readable program code configured to provide one or more of:
additional non-visual feedback; and
an execution of the underlying control.
